(19) United States
(12) Patent Application Publication
(10) Pub. No.: US 2026/0266999 A1
(43) Pub. Date: Sep. 10, 2026

(54) Method and System for Evaluating the Posture of a Cyclist, and Bicycle

(71) Applicant: Canyon Bicycles GmbH, Koblenz (DE)

(72) Inventors: Mazen Jrab, Frankfurt am Main (DE); Kyle Debelak, Stuttgart (DE)

(21) Appl. No.: 19/560,249

(22) Filed: Mar. 9, 2026

(30) Foreign Application Priority Data
Mar. 10, 2025 (DE) 102025108858.6

(51) Int. Cl. G01S 17/88; B62J 45/41; B62J 45/422; B62J 50/22

(52) U.S. Cl. CPC G01S 17/88; B62J 45/41; B62J 45/422; B62J 50/22

(57) ABSTRACT

A method for evaluating, in particular aerodynamically, the posture of a cyclist, using a sensor arranged on the bicycle, the method including the steps of detecting the posture, in particular of the upper body, of the cyclist when cycling by means of the sensor, and outputting information about the posture. Furthermore, the invention relates to a system for evaluating the posture of a cyclist, in particular aerodynamically, and to a bicycle.

### CROSS-REFERENCE TO RELATED APPLICATION

This application claims priority to German Patent Application No. 102025108858.6 filed Mar. 10, 2025, the disclosure of which is hereby incorporated by reference in its entirety.

### BACKGROUND OF THE INVENTION

### Field of the Invention

The invention relates to a method and a system for evaluating, in particular aerodynamically, the posture of a cyclist. The invention also relates to a bicycle having such a system.

### Description of Related Art

The posture of cyclists and the resulting aerodynamics have a decisive influence on the cyclist's performance. Previous approaches to optimizing posture include, for example, an evaluation of video footage of the cyclist or an assessment by third parties, e.g. trainers. The adjustment of the cyclist's posture while riding, in particular to achieve the best possible aerodynamics, is generally based on the cyclist's experience and/or feeling.

The problem here is that an optimal posture is often not achieved, e.g. not over a longer period of time and/or adapted to the current situation and circumstances.

### SUMMARY OF THE INVENTION

The object of the invention is to provide a method and a system for evaluating, in particular optimizing, the posture when cycling, preferably while cycling.

According to the invention, the object is achieved by a method, a system, and a bicycle described herein.

The method according to the invention for evaluating the posture of a cyclist, in particular aerodynamically, is carried out by means of a sensor arranged on the bicycle. The method comprises the step of detecting the posture, in particular of the upper body, of the cyclist when cycling by means of the sensor. Furthermore, the method comprises the step of outputting information about the posture based on the detected posture. In particular, the information can be output directly to the cyclist, i.e. live during the ride, and/or it can be transmitted to another location, e.g. via the Internet, and/or it can be recorded and played back later. Preferably, the information about the posture is provided by means of a control unit, in particular one connected to the bicycle. In particular, the control unit is set up to evaluate the posture detected by the sensor. The evaluation can be carried out, for example, using a mobile device that is connected to the sensor via data transmission, e.g. via Bluetooth. Thus, the mobile device corresponds in particular to the control unit. A mobile device in the context of the present disclosure is in particular a cell phone, such as a smartphone, or a wearable, such as a smartwatch.

It is preferred that the sensor is connected to the handlebar, the handlebar stem, the handlebar tube and/or the top tube of the bicycle, e.g. integrated into it. It is possible, for example, that the sensor is embedded in the handlebar, the handlebar stem, the handlebar tube and/or the top tube.

Furthermore, the invention comprises a system for evaluating the posture of a cyclist, in particular aerodynamically. The system comprises a sensor to be arranged on the bicycle or arranged thereon, wherein the sensor is set up and in particular aligned to detect the posture, in particular of the upper body, of the cyclist when cycling. Furthermore, the system comprises a control unit, in particular connected to the bicycle, for evaluating the posture detected by the sensor. For example, the control unit comprises the STM832F401 microcontroller or consists thereof.

The features described below relate in particular to the method according to the invention and/or the device according to the invention.

It is preferable that the sensor is an optical sensor that detects the posture of the cyclist.

It is preferred that the sensor is a time-of-flight (ToF) sensor. The sensor, in particular the ToF sensor, is in particular a sensor that emits light, preferably with a wavelength of approx. 940 nm, particularly preferably infrared light, as a measurement signal. The Tof sensor is a VL53L8, for example. Instead of or in addition to the ToF sensor, a lidar sensor and/or an ultrasonic sensor array can be used as a sensor, for example.

It is preferred that the sensor measures the distance between several areas of the body, in particular of the upper body. Preferably, the sensor measures the distance of the several areas of the body to the sensor and/or to the mounting location on the bicycle. In particular, the sensor is configured to detect the body, preferably the upper body, relative to the bicycle. Preferably, the measured distance, e.g. by means of the control unit, is used to detect the posture. In particular, the sensor is set up to detect the body, preferably the upper body, of the cyclist as a grid, e.g. a checkerboard grid. The grid has several measuring points, e.g. at least four, preferably at least 16, particularly preferably at least 36 measuring points. For example, the grid can have at least 4x4, at least 6x6 or at least 8x8 measuring points. The sensor, e.g. the ToF sensor, scans the body of the cyclist, in particular as a grid, so that the measurement signal emitted by the sensor, e.g. light, preferably hits the body in the form of a grid. It is preferable that the upper body is detected in terms of area, wherein it is particularly preferable that the upper body is detected in three dimensions.

Preferably, the detected values, in particular the measured distances, are used to determine, preferably extrapolate, the geometry, e.g. a model, of the current posture is determined, e.g. by means of the control unit. For example, at least one, several or all of the following postures can be determined: a climbing position, an upright position, a freehand riding position, a one-handed riding position and at least one or several aero positions. The body postures to be determined also include, in particular, a grip posture of the cyclist, wherein, for example, an upper handlebar grip, a lower handlebar grip, a brake grip and/or an aerobar grip can be determined.

It is preferred that the method comprises the further step of detecting wind acting on the cyclist, e.g. crosswind, tailwind and/or headwind. In particular, the bicycle comprises a wind sensor for detecting the wind. Additionally or alternatively, the method comprises in particular the further step of detecting the power. In particular, the bicycle comprises a power meter for detecting the power. In particular, a CdA (coefficient of drag area) is measured using the detected power and/or wind. Preferably, it is thus determined when the cyclist is in the best aerodynamic position. Furthermore, in particular machine learning can be used to analyze the aerodynamics of a cyclist, for example during a short training phase, and thus individually determine the optimum riding posture. This data is then used to make personalized recommendations to the cyclist to improve aerodynamics and/or riding performance. This makes it particularly advantageous to provide individual, rather than general, predefined data on the best aerodynamic position.

It is preferred that the method comprises the further step of simulating the aerodynamics of the cyclist based on the detected posture. Preferably, the detected wind is included in addition to the posture, e.g. the determined geometry, to simulate the aerodynamics. In particular, the control unit is set up to simulate the aerodynamics.

It is preferred that the method comprises the further step of outputting a change suggestion, in particular an optimization suggestion, to the cyclist for adjusting the aerodynamics. The change suggestion is preferably generated based on the detected posture, e.g. the determined geometry, the simulated aerodynamics and/or the detected wind. In particular, the change proposal is generated by means of the control unit.

It is preferable that calculation steps, e.g. simulation and/or determination, are carried out alternatively or additionally by outputting information using a mobile device, in particular a mobile device the cyclist. In particular, the system comprises a corresponding mobile device.

It is preferred that the system has a feedback device to be arranged on the bicycle or arranged on the bicycle to output information based on the detected posture. The feedback device comprises, for example, a display, a loudspeaker and/or a light indicator, in particular comprising an LED. The display is, for example, a mobile device display or a display integrated with the bicycle. The information is output as part of the method according to the invention, in particular using the feedback device.

In particular, the method is carried out and/or the posture is detected over a longer period of time, preferably continuously. In particular, the data is detected and/or output live, i.e. while cycling.

The invention also relates to a bicycle, in particular a racing bicycle, having a system according to the invention for evaluating the posture, wherein the sensor is connected to the bicycle frame of the bicycle.

It is preferred that the system, in particular the sensor, is connected to the handlebar, the handlebar stem, the handlebar tube and/or the top tube of the bicycle, e.g. integrated into it. It is possible, for example, that the sensor is embedded in the handlebar, the handlebar stem, the handlebar tube and/or the top tube. Alternatively or additionally, it is particularly possible that the system, preferably the sensor, has a fixing device, preferably for detachable fixing to the bicycle.

### BRIEF DESCRIPTION OF THE DRAWINGS

In the following, the invention is described in more detail by means of preferred embodiments with reference to the accompanying drawings. The terms Fig., Figs., Figure, and Figures are used interchangeably in the specification to refer to the corresponding figures in the drawings.

### In the Figure

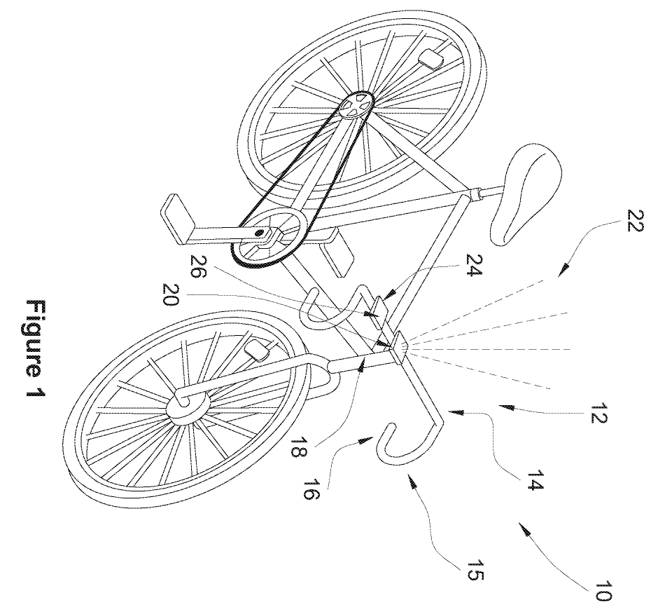

FIG. 1 shows a schematic illustration of an embodiment of a bicycle according to the invention with an embodiment of a system according to the invention.

### DESCRIPTION OF THE INVENTION

FIG. 1 shows a bicycle 10, which is a racing bike. The bicycle 10 comprises a handlebar 12 with an upper grip 14, a lower grip 16 and a brake lever 15 therebetween.

A system 18 for evaluating the posture of a cyclist (not shown), in particular aerodynamically, is connected to the handlebar 12.

The system 18 comprises a sensor 20, in particular a ToF sensor, and a display 24. The sensor 20 and display 24 are shown connected to the handlebar 12, for example by means of a fixing device (not shown). Alternatively, it is possible in particular for the sensor 20 and/or the display 24 to be integrated into the handlebar, e.g. embedded therein.

The sensor 20 emits measurement signals 22, in particular light, for detecting the posture, preferably of the upper body, of the cyclist (not shown). It is possible that, for example, the grip positions of the cyclist, e.g. a grip on the upper handlebar 14, on the brake lever 15 or on the lower handlebar 16, is also detected.

Information 26 about the posture can then be shown on the display 24. For example, information can be provided to the cyclist on how to adjust the posture to implement optimum aerodynamics of the cyclist. Such information can be provided, for example, by means of text and/or a pictogram of the cyclist, with change suggestions being displayed. Additionally or alternatively, a handle change can be suggested. The information to be output is provided in particular via a control unit (not shown), which can be integrated into the sensor 20, for example.

Instead of the illustrated embodiment with an extra display 24, it is also possible in particular for the information to be output on a mobile device, e.g. a cell phone or a smartwatch, of the cyclist. For example, it is possible to transmit data from the sensor 20 to the mobile device via Bluetooth. It is also conceivable, for example, that the detected posture is stored and/or transmitted externally, e.g. for evaluation and/or monitoring.

In particular, the method according to the invention can be carried out with the embodiment shown.

1. A method for evaluating the posture of a cyclist while positioned on a bicycle, in particular aerodynamically, comprising
providing a sensor on the bicycle,
detecting the posture, of the upper body, of the cyclist when cycling, and
outputting information about the posture.

2. The method according to claim 1, wherein the sensor is connected to the handlebar, the handlebar stem, the handlebar tube and/or the top tube of the bicycle, e.g. integrated into it.

3. The method according to claim 1, wherein the sensor is an optical sensor.

4. The method according to claim 3, wherein the sensor is a time-of-flight, ToF, sensor.

5. A method according to claim 1, wherein the sensor measures the distance between several areas of the body, in particular the upper body.

6. The method according to claim 1, wherein the method comprises the further step of:
detecting wind acting on the cyclist.

7. The method according to claim 1, wherein the method comprises the further step of:
simulating the aerodynamics of the cyclist based on the detected posture.

8. The method according to claim 1, wherein the method comprises the further step of:
outputting a modification suggestion, in particular an optimization suggestion, to the cyclist for adjusting the aerodynamics.

9. The method according to claim 1, wherein calculation steps and/or outputs are carried out by means of a mobile device, in particular of the cyclist.

10. A system for evaluating the posture of a cyclist, in particular aerodynamically, comprising
a sensor to be arranged on the bicycle, in particular a ToF sensor, the sensor being set up to detect the posture, in particular of the upper body, of the cyclist when cycling, and
a control unit, in particular connected to the bicycle, for evaluating the posture detected by the sensor.

11. The system according to claim 10, wherein the system has a feedback device to be arranged on the bicycle or arranged on the bicycle, for example comprising a display, a loudspeaker and/or a light indicator, for outputting information based on the detected posture.

12. A bicycle, in particular a racing bicycle, comprising a system according to claim 10, wherein the sensor is connected to the bicycle frame of the bicycle.

13. The bicycle according to claim 12, wherein the sensor is connected to the handlebar, the handlebar stem, the handlebar tube and/or the top tube of the bicycle, e.g. integrated into it.
